(19) United States
(12) Patent Application Publication
(10) Pub. No.: US 2026/0157912 A1
(43) Pub. Date: Jun. 11, 2026

(54) Hip and Leg Stretching Apparatus

(71) Applicant: John D'Amario, Alameda, CA (US)

(72) Inventor: John D'Amario, Alameda, CA (US)

(21) Appl. No.: 18/976,136

(22) Filed: Dec. 10, 2024

(51) Int. Cl. A61H 1/02

(52) U.S. Cl. CPC A61H 1/0244; A61H 2001/0248; A61H 2201/0192; A61H 2201/1238; A61H 2201/149; A61H 2201/1626; A61H 2201/1633; A61H 2201/1635; A61H 2203/0425

(57) ABSTRACT

A saddle stretch apparatus may comprise a base frame. An adjustable height mechanism may be coupled to the base frame. A saddle seat may be coupled to the adjustable height mechanism. A pair of leg lifting arms may be coupled to the base frame. A gear mechanism may be operatively connected to the leg lifting arms. A control handle may be operatively connected to the gear mechanism for adjusting the position of the leg lifting arms.

### FIELD OF THE INVENTION

The present disclosure relates generally to exercise equipment, and more particularly to a stretching apparatus for improving flexibility in the legs and hips.

### BACKGROUND

Flexibility is an important aspect of physical fitness and performance in various activities, including martial arts, dancing, and sports. Traditional stretching methods often involve sitting on the ground or using equipment that may not provide optimal comfort or support during the stretching process. Many existing stretching devices require users to be in a seated position, which can limit the effectiveness of the stretch and may cause discomfort or strain.

There is a need for an improved stretching apparatus that allows users to comfortably and effectively stretch their legs and hips while maintaining a relaxed, upright position. Such an apparatus should accommodate users with varying levels of flexibility and provide a safe, controlled stretching experience.

### SUMMARY

The present disclosure provides a saddle stretch apparatus designed to allow users to stretch their legs, hips, and torso in multiple directions and angles while remaining in a comfortable, upright position. The apparatus utilizes the user's own weight and gravity to create resistance, making it suitable for users with varying levels of flexibility. In one aspect, a saddle stretch apparatus may include a base frame, an adjustable height mechanism, a saddle seat, a backrest support, leg lift pads, and a hydraulic or pneumatic pump system. The apparatus may be configured to support a user in an upright position while allowing for controlled stretching of the legs and hips. In another aspect, a method of using the saddle stretch apparatus may include mounting the apparatus, adjusting the height, positioning the legs on the lift pads, operating a control handle to raise the lift pads, maintaining a desired stretch position, and gradually lowering the lift pads using a release mechanism. These and other features, aspects, and advantages of the present disclosure will become better understood with reference to the following description and appended claims.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items. The accompanying drawings, which are incorporated in and constitute a part of this specification, illustrate embodiments of the disclosure and, together with a general description of the disclosure given above, and the detailed description given below, serve to explain the principles of the disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure.

FIG. 1 illustrates front and side views of a saddle stretch apparatus according to an embodiment of the present disclosure.

FIG. 2 shows an example of taekwondo fighters demonstrating the importance of flexibility in martial arts.

FIG. 3 depicts a diagram of a hydraulic pump jack chair.

FIG. 4 shows an example of a saddle stool with a split seat design.

FIG. 5 illustrates various examples of saddle-style seats.

FIG. 6 shows a diagram of a person in an upright position on a saddle with legs spread apart.

FIG. 7 illustrates a side view of a person seated on the saddle stretch apparatus.

FIG. 8 depicts a person performing a forward leg stretch on the apparatus.

FIG. 9 shows saddle stretch sketches with various components labeled.

FIG. 10 illustrates a person in a standing split position on the apparatus.

FIG. 11 depicts side and front views of the apparatus in different stretching positions.

FIG. 12 shows various views of a leg lift pad component.

FIG. 13 illustrates key features of the apparatus, including the base and optional monitor.

FIG. 14 shows a person standing beside the apparatus with labeled components.

FIG. 15 depicts an example of a ball joint gear mechanism.

FIGS. 16-18 show front, side, and perspective views of a person using the apparatus.

FIG. 20 illustrates an exploded view of the saddle assembly.

FIGS. 21-23 show various positions and design concepts of the apparatus.

FIG. 24 depicts a saddle chair for reference in seat and height adjustability design.

FIG. 25 shows an isometric view of geared leg lifting arms.

### DETAILED DESCRIPTION

The present disclosure provides a saddle stretch apparatus designed to allow users to stretch their legs, hips, and torso in multiple directions and angles while remaining in a comfortable, upright position. The apparatus utilizes the user's own weight and gravity to create resistance, making it suitable for users with varying levels of flexibility.

The present disclosure provides a saddle stretch apparatus that may allow users to stretch their legs, hips, and torso in multiple directions and angles while remaining in a comfortable, upright position. The apparatus may utilize the user's own weight and gravity to create resistance, providing an effective stretching experience for individuals with varying levels of flexibility. In one aspect, a saddle stretch apparatus may comprise a base, a vertical support structure extending upwardly from the base, a saddle seat mounted on the vertical support structure, and at least one leg lift pad operatively connected to the vertical support structure. The apparatus may further include a hydraulic lift mechanism for adjusting the height of the saddle seat, and adjustment mechanisms for positioning the leg lift pad in various directions and angles.

In another aspect, a method of using a saddle stretch apparatus may comprise mounting the apparatus in an upright position, selecting a desired stretch type, inputting desired stretch parameters, engaging in a stretching exercise while maintaining a relaxed, upright position, adjusting stretch intensity by shifting body weight, holding the stretch for a desired duration, and returning to a neutral position.

The present disclosure provides a saddle stretch apparatus that may allow users to perform a wide range of stretches while maintaining a comfortable, upright position. The apparatus may be suitable for use in various settings, including fitness centers, gyms, rehabilitation facilities, sports training centers, and home environments. It may cater to users with varying levels of flexibility and may be used to complement various physical activities such as martial arts, running, golf, soccer, and general exercise routines.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

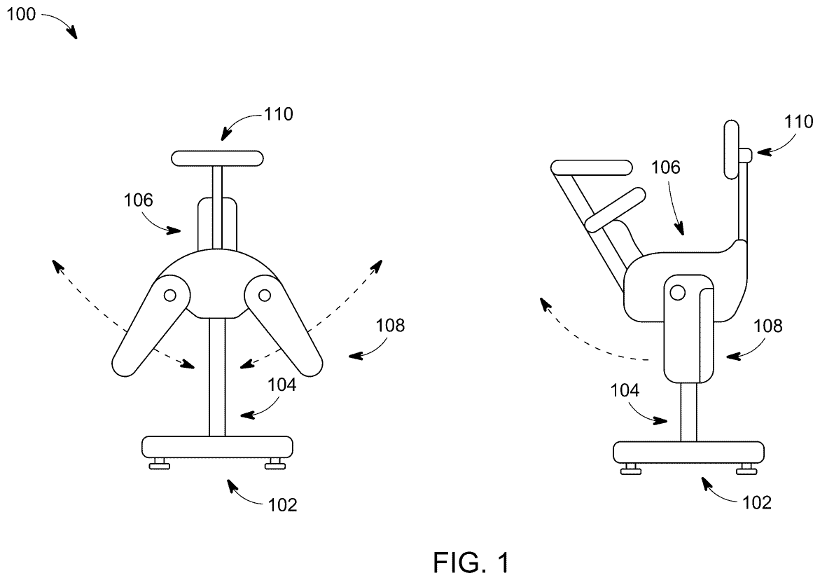

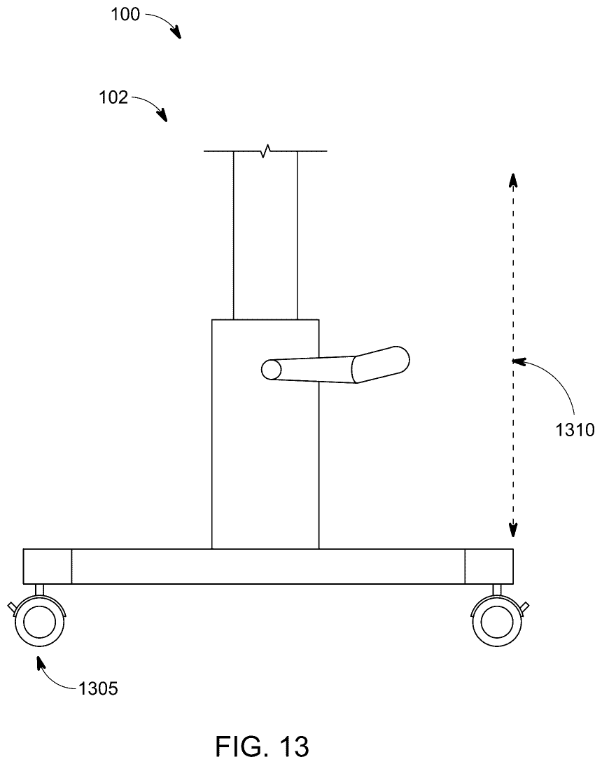

Referring now to FIG. 1, a saddle stretch apparatus 100 according to an embodiment of the present disclosure is illustrated. The apparatus 100 may comprise a base 102, a vertical support structure 104 extending upwardly from the base 102, a saddle seat 106 mounted on the vertical support structure 104, and at least one leg lift pad 108 operatively connected to the vertical support structure 104. The apparatus 100 may further include a handlebar 110 for user support and a hydraulic pump jack 112 for adjusting the height and position of the saddle seat 106 and leg lift pads 108. The base 102 may be designed to provide stability and support for the entire apparatus 100. In some embodiments, as shown in FIG. 13, the base 102 may include lockable casters 1305 to allow for easy movement and positioning of the apparatus 100. The base 102 may also include features for adjusting the height of the vertical support structure 104. The vertical support structure 104 may be a sturdy column that supports the saddle seat 106 and houses the hydraulic lift mechanism. The vertical support structure 104 may be made of high-strength steel or other suitable materials designed to withstand the forces applied during use of the apparatus 100.

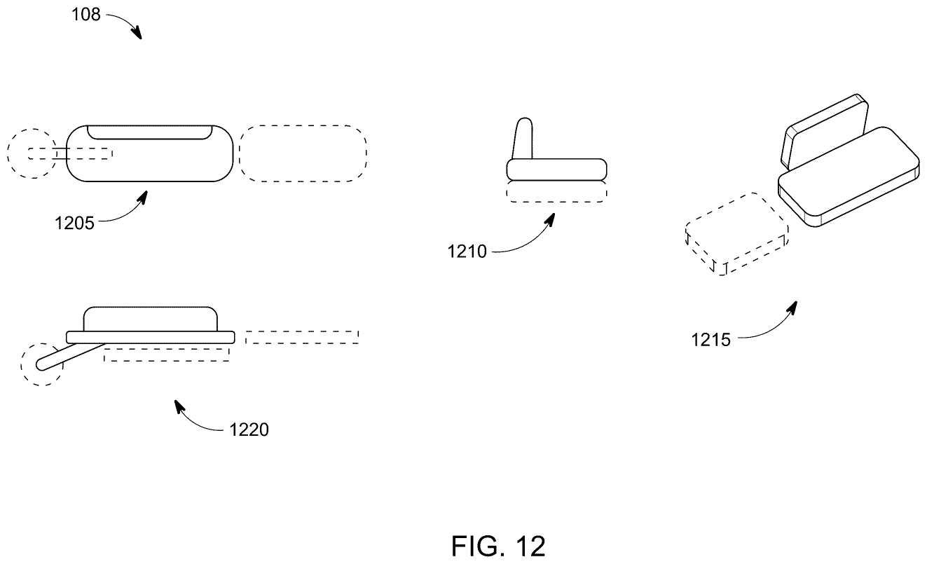

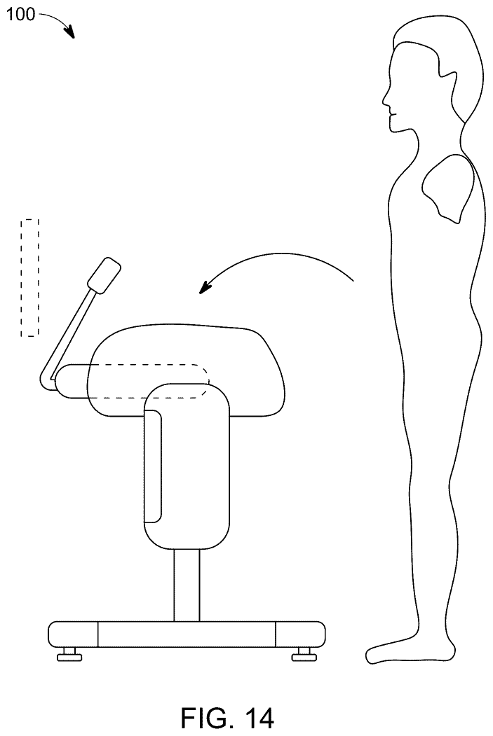

The saddle seat 106 may be ergonomically designed to mimic a horse saddle, providing comfort and stability for the user. As illustrated in FIG. 14, the saddle seat 106 may include an optional backrest 305 for additional support. The saddle seat 106 may be made of leather, rubber, vinyl, or other durable and comfortable materials that can withstand repeated use. The leg lift pads 108 may be designed to support and guide the user's legs during stretching exercises. As shown in FIG. 12, each leg lift pad 108 may include a wheel or gear mechanism 300 that allows for 90-degree movement. The leg lift pads 108 may also include optional extension pads that can slide out or fold up to accommodate different leg lengths and stretching positions.

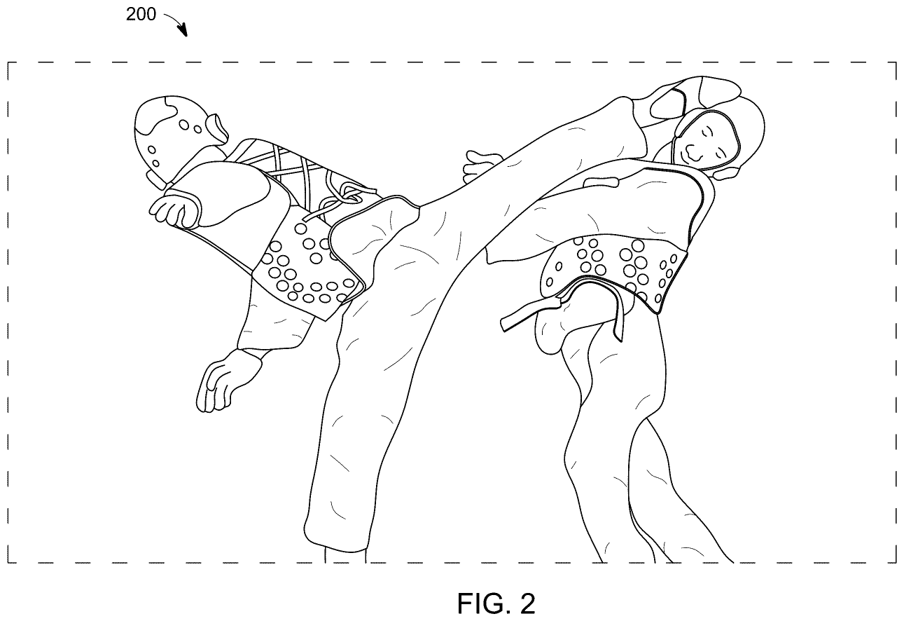

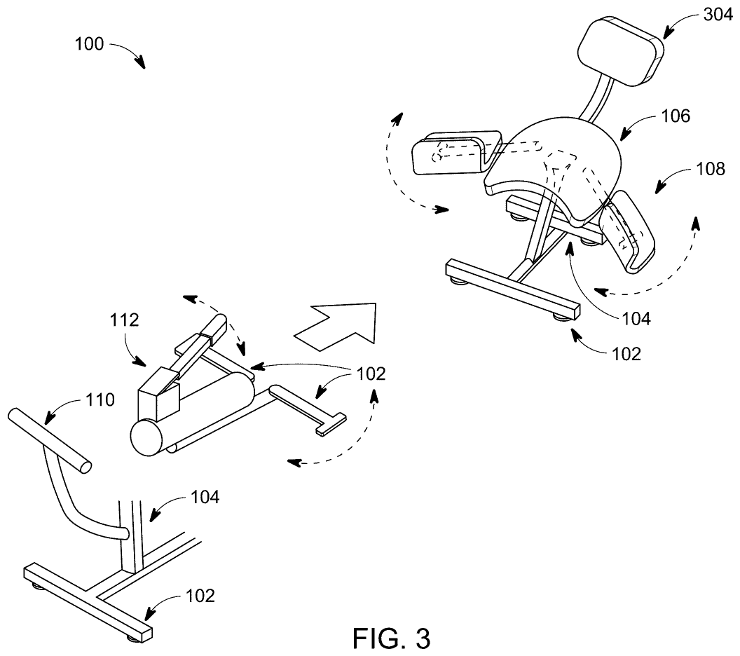

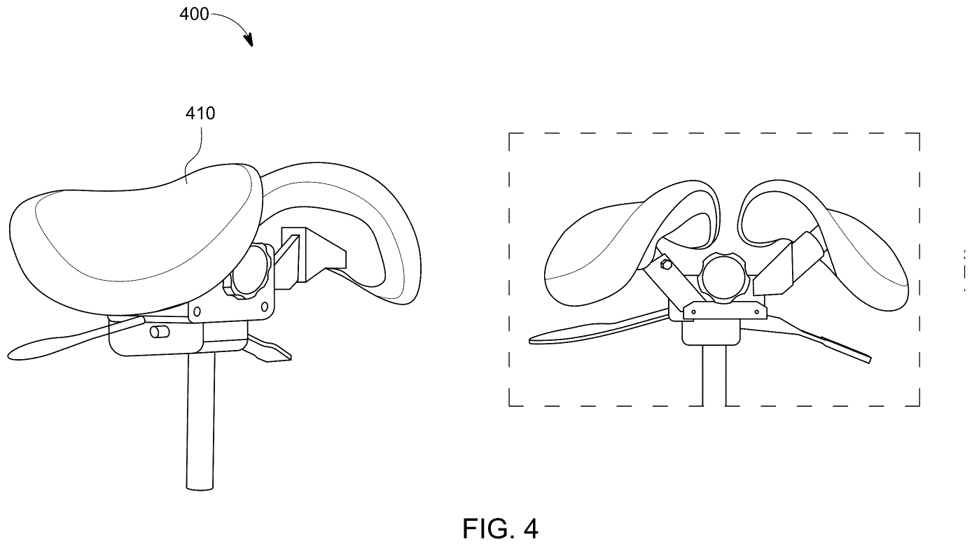

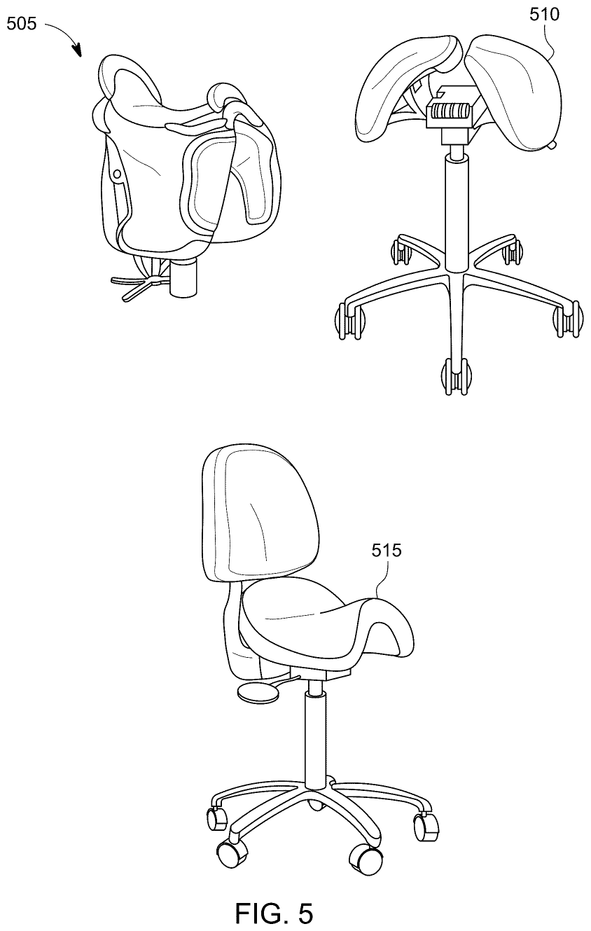

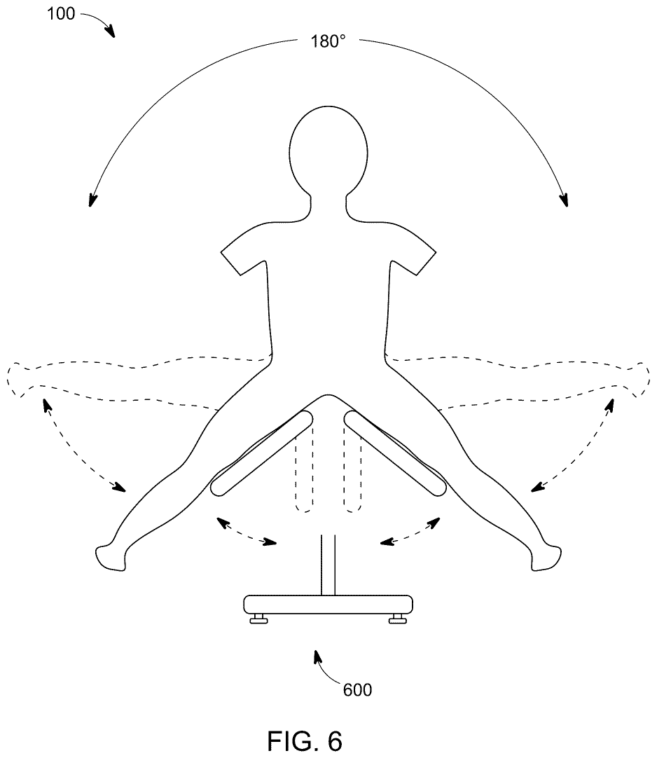

Regarding FIGS. 2, 200 it illustrates a photograph demonstrating flexibility in Taekwondo fighters, illustrating the type of flexibility that may be achieved using the saddle stretch apparatus. FIGS. 3, 304 illustrates of a hydraulic jack that may be used in the saddle stretch apparatus 100. FIG. 4 is an image of a Kanewell Twin Adjustable Saddle Stool 410, which may be used as a reference for the saddle design in the present disclosure. FIG. 5 shows images of saddle stools 505, 510, and 515 demonstrating design features for comfort and adjustable height. FIGS. 6, 600 is a front/back view illustration of a person using the saddle stretch apparatus 100, demonstrating the range of motion from a closed to open position.

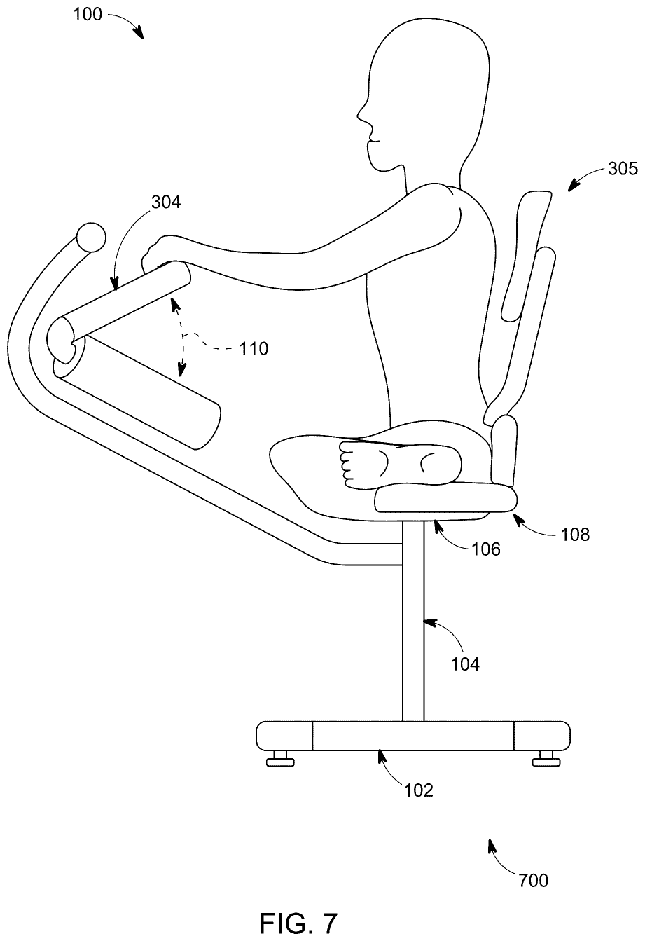

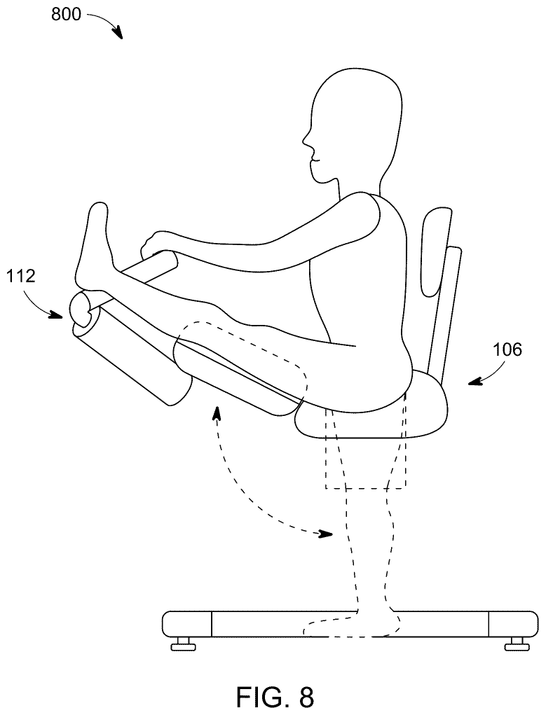

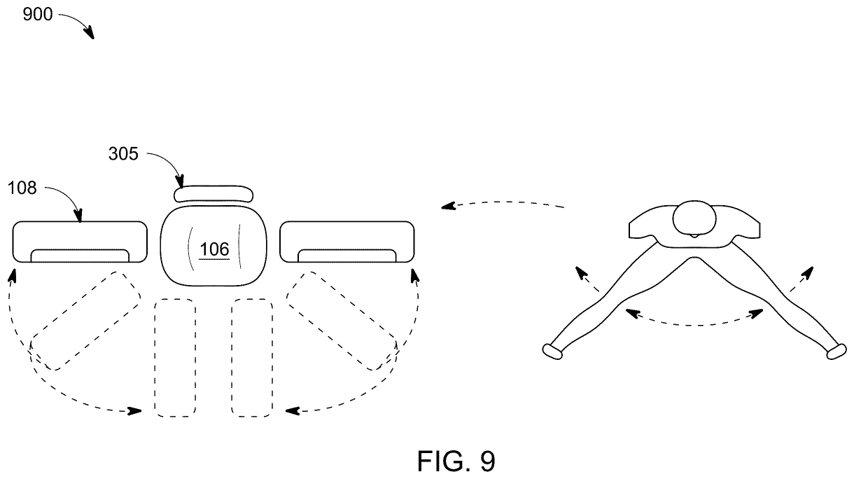

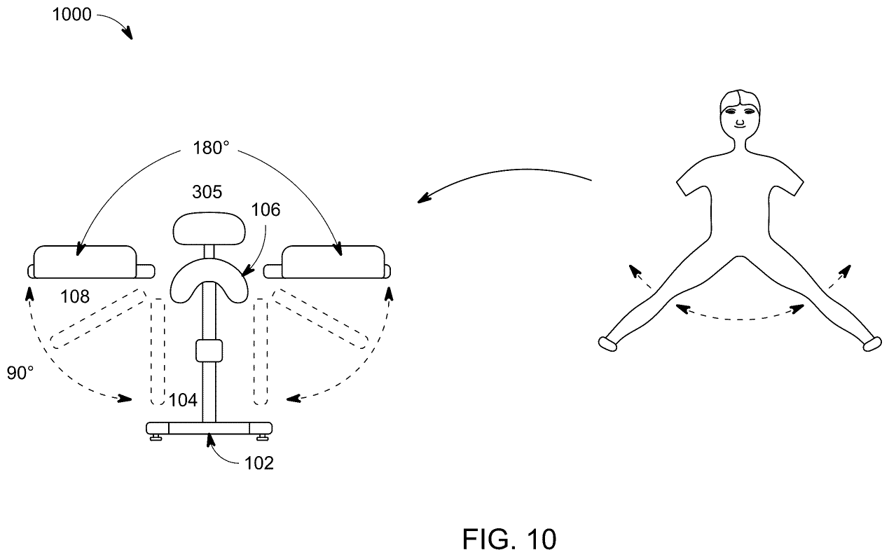

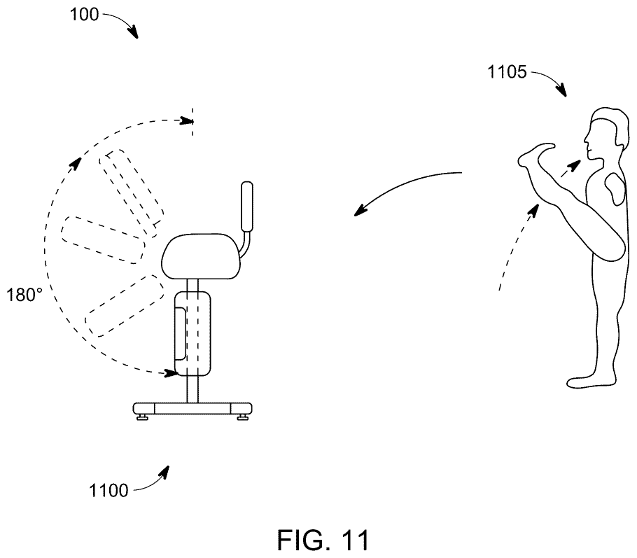

Regarding FIGS. 7, 700 is a side view illustration of a person using the saddle stretch apparatus 100 in a full Russian split position. FIGS. 8, 800 is a side view illustration of a person using the saddle stretch apparatus for a forward front leg stretch. FIGS. 9, 900 is a top view sketch of the saddle stretch apparatus showing optional features and components. FIGS. 10, 1000 is a front view sketch of the saddle stretch apparatus illustrating the range of motion for the leg lift pads. FIG. 11 is a side view sketch 1100 of the saddle stretch apparatus showing the front lift stretch position 1105. FIG. 12 is a multi-view illustration of the leg lift pad component 108, including top 1205, front 1210, side 1220, and isometric 1215 views. FIG. 13 is an illustration of the base component with lockable casters 1305 and height adjustment features 1310. FIG. 14 is an illustration of the saddle component with annotations for various features.

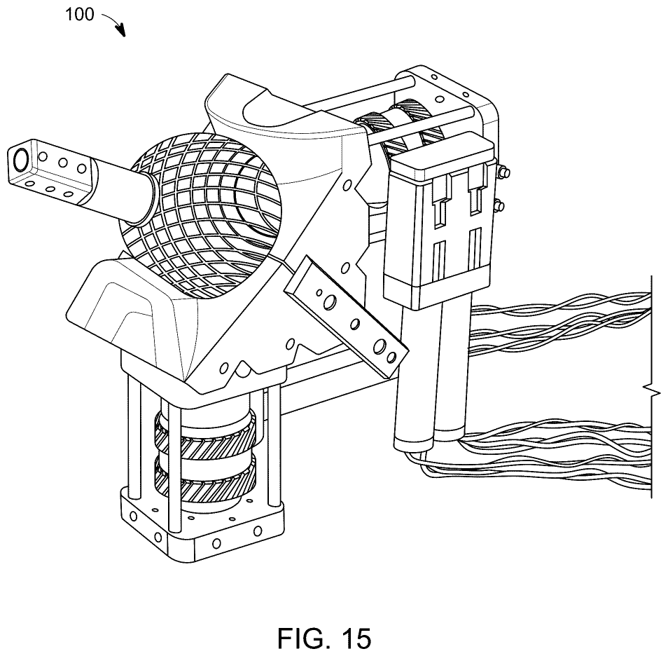

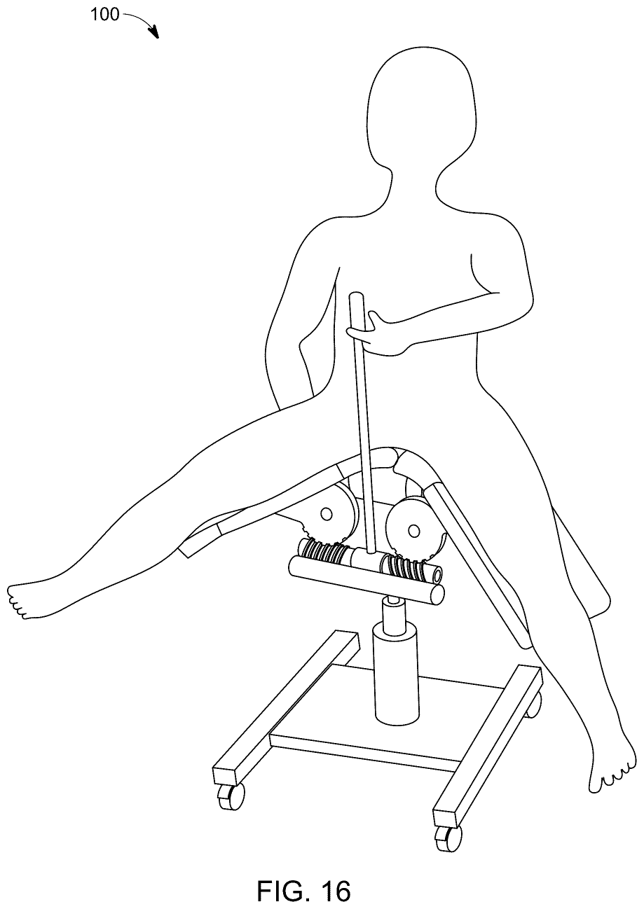

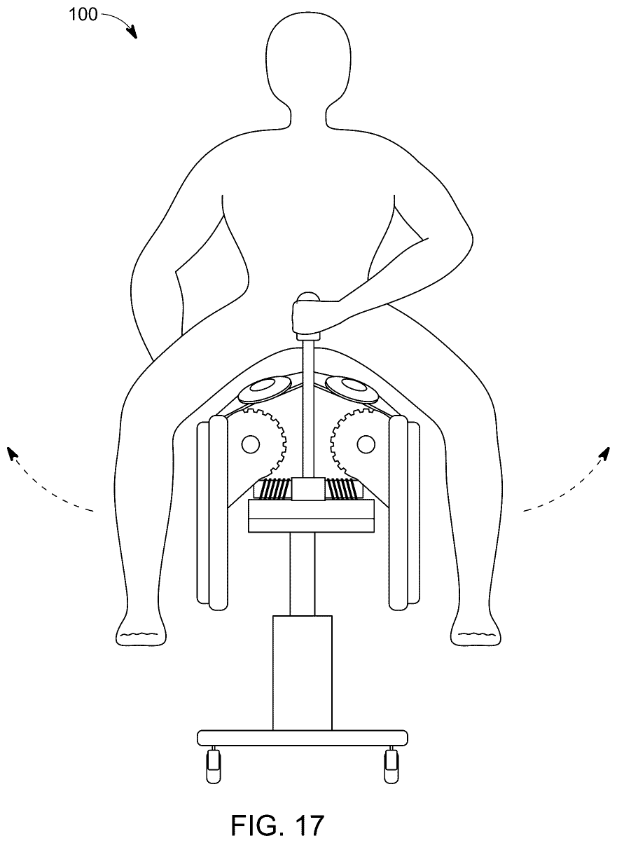

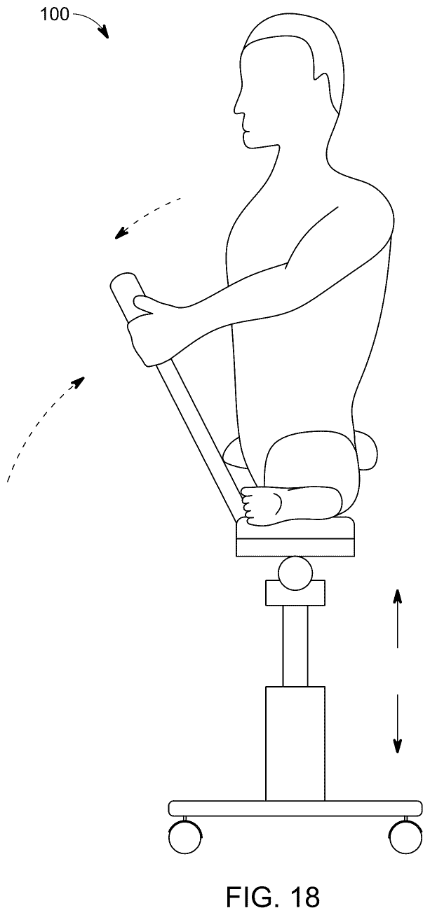

FIG. 15 is an illustration of a ball joint gear assembly 1505 that may be used in the leg lift pad adjustment mechanism.

The hydraulic pump jack 112 may be used to adjust the height of the saddle seat 106 and the position of the leg lift pads 108. As illustrated in FIG. 3, the hydraulic jack may include a release button to gradually lower the thigh lifts to any desired position. The hydraulic system may be designed to be replaceable in the event of failure, ensuring the longevity of the apparatus 100.

In some embodiments, the apparatus 100 may include a control panel (not shown) that allows users to adjust the height, angle, and direction of the saddle seat 106 and leg lift pads 108. The control panel may also include safety features such as an emergency stop button.

The apparatus 100 may be designed to allow for multiple stretching positions and exercises. As illustrated in FIG. 6, the leg lift pads 108 may open to allow for a full Russian split position, with the user's legs spread at up to 180 degrees. FIG. 7 shows a side view of this position, demonstrating how the user can maintain an upright posture while performing the stretch.

FIG. 8 illustrates how the apparatus 100 may be used for a forward front leg stretch. In this position, the leg lift pads 108 may be rotated to support the legs in a forward position. As noted in FIG. 11, this stretch may require stirrups on the base to hold the user's foot in place. The apparatus 100 may utilize a ball joint gear mechanism, as shown in FIG. 15, to allow for full multi-directional movement of the lifting pads. This mechanism may enable the leg lift pads 108 to be positioned at various angles and directions, providing a wide range of stretching options.

In operation, a user may mount the saddle stretch apparatus 100 in an upright position, similar to sitting on a horse. The user may then select a desired stretch type, such as a leg, hip, or torso stretch. Using the control panel or handlebar 110, the user may input desired stretch parameters, such as the height of the saddle seat 106 and the position of the leg lift pads 108. The user may then engage in the stretching exercise while maintaining a relaxed, upright position. The user may adjust the stretch intensity by shifting their body weight and using the hydraulic system to adjust the position of the leg lift pads 108. The user may hold the stretch for a desired duration before returning to a neutral position.

The saddle stretch apparatus 100 may provide several advantages over traditional stretching devices. By allowing users to maintain an upright position, the apparatus 100 may enable more comfortable and effective stretching exercises. The use of hydraulic mechanisms may provide smooth and controlled movements, reducing the risk of injury. The multi-directional capabilities of the leg lift pads 108 may allow for a wide range of stretching exercises, catering to users with different flexibility levels and stretching goals.

The hydraulic lift mechanism may include a release button for gradually lowering the at least one leg lift pad to any desired position. In some embodiments, the release button may be located on or near the saddle seat for easy access by the user. The release button may be operatively connected to a valve in the hydraulic system that controls the flow of hydraulic fluid.

When activated, the release button may open the valve to allow a controlled flow of hydraulic fluid, resulting in a slow and steady lowering of the leg lift pad. The rate of descent may be adjustable to accommodate different user preferences and flexibility levels. The release button may also include a locking mechanism to maintain the leg lift pad at any intermediate position during lowering. The hydraulic lift mechanism may further include safety features to prevent sudden drops. For example, a pressure relief valve may be incorporated to limit the maximum lowering speed. Additionally, the system may include a backup mechanical locking mechanism that engages automatically if hydraulic pressure is lost.

In some embodiments, the hydraulic lift mechanism may include multiple release buttons or controls to independently adjust different leg lift pads. This may allow for asymmetrical stretching exercises or accommodating users with different flexibility levels in each leg. The hydraulic system may be designed for smooth and quiet operation. It may utilize high-quality seals and hydraulic fluid to minimize leakage and maintenance requirements. The hydraulic components may be easily accessible for servicing when needed.

In alternative embodiments, the lift mechanism may utilize a pneumatic system instead of hydraulics. The pneumatic system may offer similar functionality in terms of controlled lifting and lowering of the leg lift pads. It may use compressed air instead of hydraulic fluid to generate the lifting force. The saddle seat may be ergonomically designed to provide comfort and support during extended stretching sessions. It may include padding and contouring to distribute the user's weight evenly. The seat material may be selected for durability and ease of cleaning.

In some embodiments, the saddle seat may include adjustable features to accommodate different user body types. For example, the seat width or angle may be adjustable. The optional backrest may also be adjustable in terms of height and angle to provide customized lumbar support. The vertical support structure may be designed to provide stability and rigidity during use. It may be constructed from high-strength materials such as steel tubing. The structure may include reinforcements or gussets at key stress points to enhance durability. The base of the apparatus may include features to enhance stability and portability. Lockable casters may allow for easy movement of the apparatus when needed, while providing a stable platform during use. The base may have a wide footprint to prevent tipping, even when significant force is applied during stretching exercises.

In some embodiments, the base may include leveling feet or adjustable supports to ensure stability on uneven surfaces. The base may also incorporate storage features, such as hooks or compartments, to hold accessories like towels or water bottles. The at least one leg lift pad may be designed for comfort and effectiveness during stretching exercises. The pad surface may be contoured to match the natural shape of the user's leg. It may be covered with a non-slip material to prevent slipping during use. The leg lift pad may include an optional extension feature to accommodate users with different leg lengths. This extension may slide out or fold up when needed. The extension mechanism may include locking positions to securely hold the extended pad in place during use. The adjustment mechanism for positioning the leg lift pad may offer a wide range of motion to accommodate various stretching positions and user flexibility levels. It may allow for adjustment in multiple planes, including rotation, tilt, and extension.

In some embodiments, the adjustment mechanism may utilize a ball joint or similar multi-axis joint to provide maximum flexibility in positioning. The joint may include locking mechanisms to securely hold the desired position once set. The apparatus may include a control panel for adjusting various parameters of the stretching exercise. This control panel may be mounted in an easily accessible location, such as on the vertical support structure or on an arm extending from it. The control panel may include controls for adjusting the height of the saddle seat, the position of the leg lift pads, and the intensity of stretches. It may also include preset programs for different types of stretching routines or user skill levels.

In some embodiments, the control panel may include a display screen to provide feedback and instructions to the user. This display may show the current settings, exercise duration, and suggested stretching techniques. The apparatus may incorporate safety features to protect the user during stretching exercises. These may include emergency stop buttons, over-extension prevention mechanisms, and padding on potential impact areas. The overall design of the saddle stretch apparatus may prioritize user comfort, effectiveness, and safety. The combination of adjustable features, hydraulic assistance, and ergonomic design may provide a superior stretching experience compared to traditional stretching methods or equipment.

The hydraulic lift mechanism may include a release button for gradually lowering the at least one leg lift pad to any desired position. In some embodiments, the release button may be located on or near the saddle seat for easy access by the user. The release button may be operatively connected to a valve in the hydraulic system that controls the flow of hydraulic fluid. When activated, the release button may open the valve to allow a controlled flow of hydraulic fluid, resulting in a slow and steady lowering of the leg lift pad. The rate of descent may be adjustable to accommodate different user preferences and flexibility levels. The release button may also include a locking mechanism to maintain the leg lift pad at any intermediate position during lowering.

The hydraulic lift mechanism may further include safety features to prevent sudden drops. For example, a pressure relief valve may be incorporated to limit the maximum lowering speed. Additionally, the system may include a backup mechanical locking mechanism that engages automatically if hydraulic pressure is lost.

In some embodiments, the hydraulic lift mechanism may include multiple release buttons or controls to independently adjust different leg lift pads. This may allow for asymmetrical stretching exercises or accommodating users with different flexibility levels in each leg. The hydraulic system may be designed for smooth and quiet operation. It may utilize high-quality seals and hydraulic fluid to minimize leakage and maintenance requirements. The hydraulic components may be easily accessible for servicing when needed.

In alternative embodiments, the lift mechanism may utilize a pneumatic system instead of hydraulics. The pneumatic system may offer similar functionality in terms of controlled lifting and lowering of the leg lift pads. It may use compressed air instead of hydraulic fluid to generate the lifting force. The saddle seat may be ergonomically designed to provide comfort and support during extended stretching sessions. It may include padding and contouring to distribute the user's weight evenly. The seat material may be selected for durability and ease of cleaning.

In some embodiments, the saddle seat may include adjustable features to accommodate different user body types. For example, the seat width or angle may be adjustable. The optional backrest may also be adjustable in terms of height and angle to provide customized lumbar support. The vertical support structure may be designed to provide stability and rigidity during use. It may be constructed from high-strength materials such as steel tubing. The structure may include reinforcements or gussets at key stress points to enhance durability. The base of the apparatus may include features to enhance stability and portability. Lockable casters may allow for easy movement of the apparatus when needed, while providing a stable platform during use. The base may have a wide footprint to prevent tipping, even when significant force is applied during stretching exercises.

In some embodiments, the base may include leveling feet or adjustable supports to ensure stability on uneven surfaces. The base may also incorporate storage features, such as hooks or compartments, to hold accessories like towels or water bottles. The at least one leg lift pad may be designed for comfort and effectiveness during stretching exercises. The pad surface may be contoured to match the natural shape of the user's leg. It may be covered with a non-slip material to prevent slipping during use. The leg lift pad may include an optional extension feature to accommodate users with different leg lengths. This extension may slide out or fold up when needed. The extension mechanism may include locking positions to securely hold the extended pad in place during use. The adjustment mechanism for positioning the leg lift pad may offer a wide range of motion to accommodate various stretching positions and user flexibility levels. It may allow for adjustment in multiple planes, including rotation, tilt, and extension.

In some embodiments, the adjustment mechanism may utilize a ball joint or similar multi-axis joint to provide maximum flexibility in positioning. The joint may include locking mechanisms to securely hold the desired position once set. The apparatus may include a control panel for adjusting various parameters of the stretching exercise. This control panel may be mounted in an easily accessible location, such as on the vertical support structure or on an arm extending from it. The control panel may include controls for adjusting the height of the saddle seat, the position of the leg lift pads, and the intensity of stretches. It may also include preset programs for different types of stretching routines or user skill levels.

In some embodiments, the control panel may include a display screen to provide feedback and instructions to the user. This display may show the current settings, exercise duration, and suggested stretching techniques. The apparatus may incorporate safety features to protect the user during stretching exercises. These may include emergency stop buttons, over-extension prevention mechanisms, and padding on potential impact areas. The overall design of the saddle stretch apparatus may prioritize user comfort, effectiveness, and safety. The combination of adjustable features, hydraulic assistance, and ergonomic design may provide a superior stretching experience compared to traditional stretching methods or equipment.

The hydraulic lift mechanism may include a release button for gradually lowering the at least one leg lift pad to any desired position. In some embodiments, the release button may be located on or near the saddle seat for easy access by the user. The release button may be operatively connected to a valve in the hydraulic system that controls the flow of hydraulic fluid. When activated, the release button may open the valve to allow a controlled flow of hydraulic fluid, resulting in a slow and steady lowering of the leg lift pad. The rate of descent may be adjustable to accommodate different user preferences and flexibility levels. The release button may also include a locking mechanism to maintain the leg lift pad at any intermediate position during lowering.

In some embodiments, the saddle seat may include adjustable features to accommodate different user body types. For example, the seat width or angle may be adjustable. The optional backrest may also be adjustable in terms of height and angle to provide customized lumbar support. The vertical support structure may be designed to provide stability and rigidity during use. It may be constructed from high-strength materials such as steel tubing. The structure may include reinforcements or gussets at key stress points to enhance durability. The base of the apparatus may include features to enhance stability and portability. Lockable casters may allow for easy movement of the apparatus when needed, while providing a stable platform during use. The base may have a wide footprint to prevent tipping, even when significant force is applied during stretching exercises.

In some embodiments, the base may include leveling feet or adjustable supports to ensure stability on uneven surfaces. The base may also incorporate storage features, such as hooks or compartments, to hold accessories like towels or water bottles. The at least one leg lift pad may be designed for comfort and effectiveness during stretching exercises. The pad surface may be contoured to match the natural shape of the user's leg. It may be covered with a non-slip material to prevent slipping during use. The leg lift pad may include an optional extension feature to accommodate users with different leg lengths. This extension may slide out or fold up when needed. The extension mechanism may include locking positions to securely hold the extended pad in place during use. The adjustment mechanism for positioning the leg lift pad may offer a wide range of motion to accommodate various stretching positions and user flexibility levels. It may allow for adjustment in multiple planes, including rotation, tilt, and extension.

Furthermore, referring again to FIG. 1, a saddle stretch apparatus 100 may include a base 102, a central vertical pole 110, and leg lifting arms 106. The leg lifting arms 106 may be configured to move within a range of zero to 90 degrees, as indicated by the arrows in the figure. The apparatus 100 may also include extensions 104 and 108, which may provide additional support or functionality. The saddle stretch apparatus 100 may be designed to accommodate users of various ages and body types. In some embodiments, the apparatus 100 may be engineered to support a minimum of 300 pounds. The apparatus 100 may be constructed from high-strength quality steel, with all working parts designed to be heavy-duty and long-lasting.

Referring to FIG. 3, the apparatus 100 may include a hydraulic pump jack 304, a back support 305, a saddle seat, thigh lift pads 108, a handle bar, lifting brackets, and a stand. The hydraulic pump system may include a release button to gradually lower the thigh lifts to any desired position.

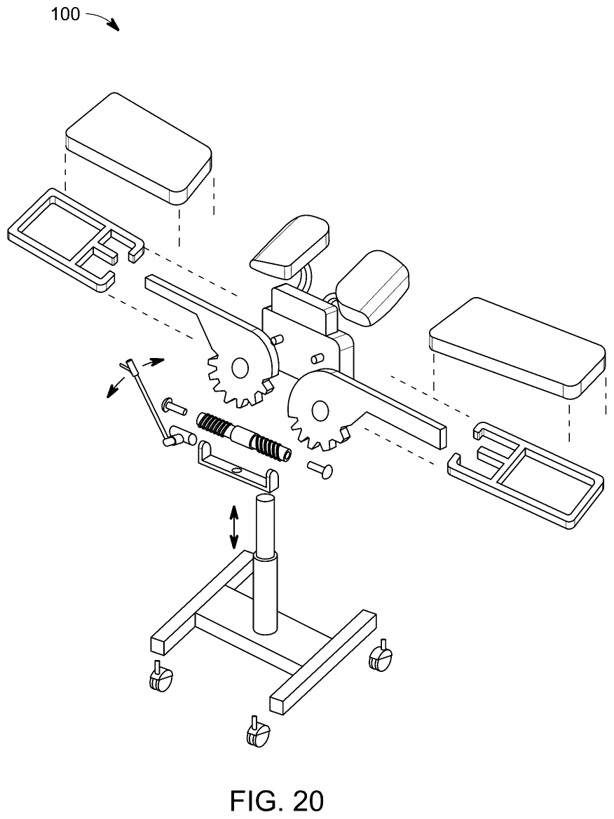

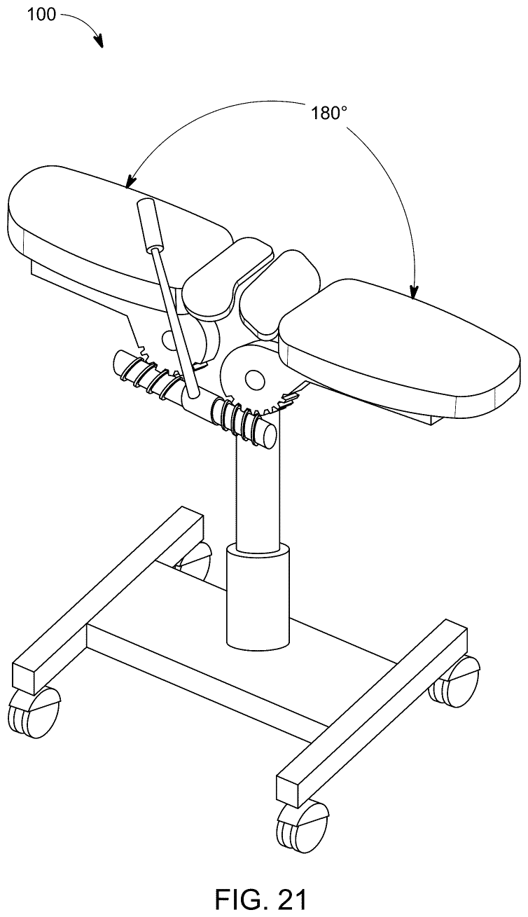

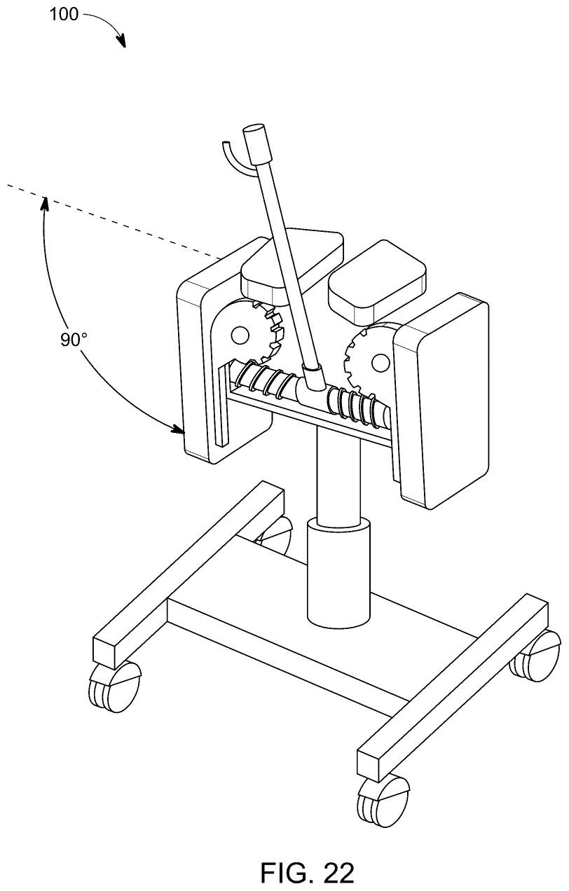

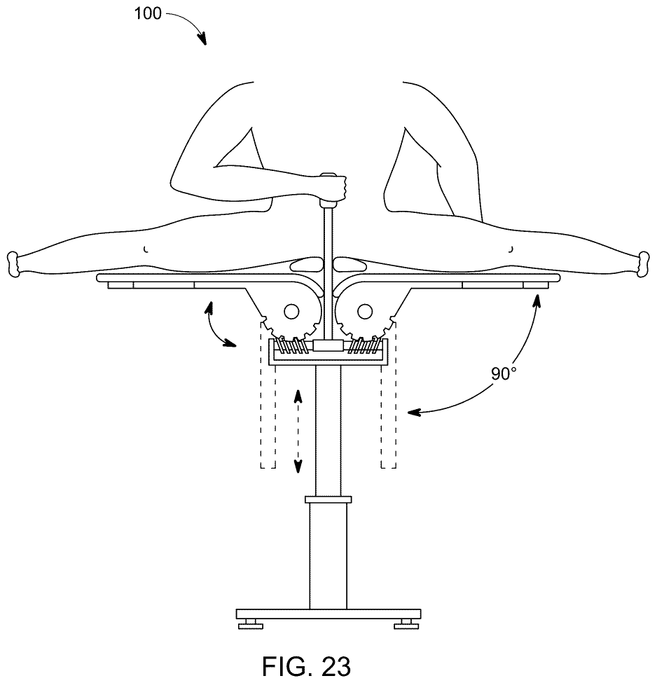

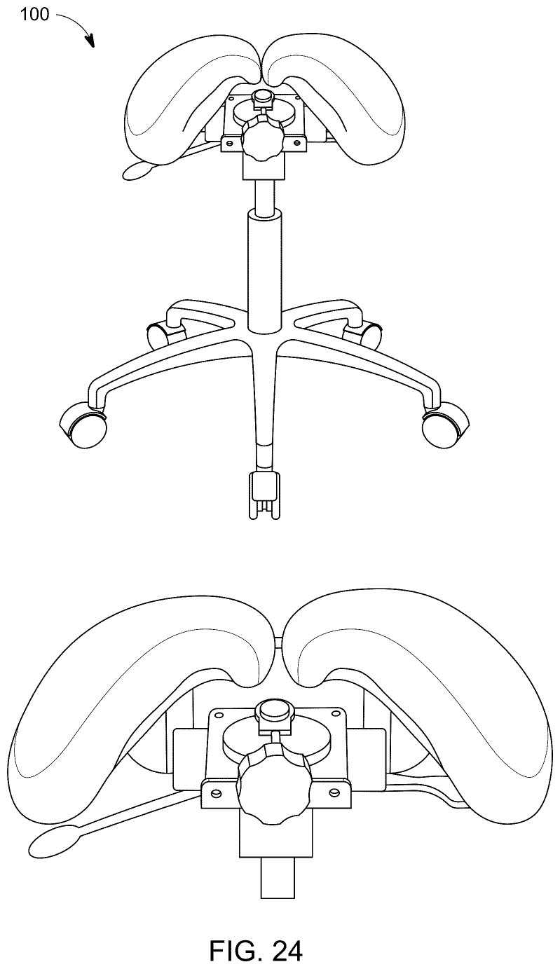

As shown in FIG. 4, the saddle seat may be designed as a split saddle pad seat 400, similar to those used by medical professionals or dentists. The saddle seat may be mounted on support bracketing 2A (FIG. 20) and may be adjustable in height to accommodate users of different statures.

Referring to FIG. 6, a user may mount the saddle stretch apparatus 100 in an upright position, with their legs spread apart. The apparatus 100 may allow for a full range of motion up to 180 degrees, as indicated by the arrows in the figure.

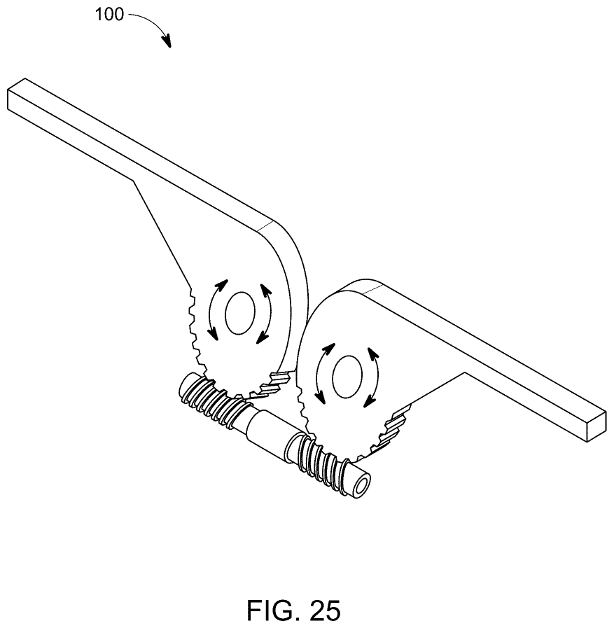

The leg lifting arms 106 (FIG. 1) may be operated manually using a handle that operates a ratchet lever. As shown in FIG. 25, the ratchet lever may rotate a worm gear 5 that operates gear mechanisms integral to the lifting arms 3. The lifting arms and gear assemblies may be engineered to lift against a force of approximately 150 pounds each.

Referring to FIG. 8, the apparatus 100 may also allow for a forward front leg stretch. The lift pads 108 may be capable of opening in two perpendicular directions (side and forward) to accommodate various stretching positions.

As shown in FIG. 20, the saddle stretch apparatus 100 may include cushion pads 1, a split saddle pad seat 2, saddle seat support bracketing 2A, leg lifting geared arms 3, cushion pad support bracket extensions 4, a worm gear 5, a worm gear bracket 6, a crank lever 7 to rotate the worm gear, an adjustable height cylinder assembly 8, and a base frame with casters 9.

The apparatus 100 may include safety features such as a locking mechanism on the ratchet lever and a release handle for controlled descent of the leg lifting arms. The hydraulic or pneumatic devices may be replaceable in the event of failure.

In some embodiments, the apparatus 100 may include an optional monitor for video instructions and coaching, as indicated in FIG. 14. The apparatus 100 may also be designed to allow for easy and safe mounting and dismounting from the rear. The saddle, back rest support, and leg lift pads may be made of durable materials such as leather, rubber, or vinyl that will not easily tear. The apparatus 100 may be designed to be 100% manual in its basic form, but could be further developed to include complex rotating gear systems, electronics, hydraulics, motors, pneumatics, display gauges, and monitors for instructional videos and coaching.

In operation, a user may approach the saddle stretch apparatus 100 from behind and mount the apparatus by straddling the split saddle seat. The user may then adjust the saddle height if necessary and engage their feet with the floor or base plate. The user may grasp the crank lever and activate the ratchet mechanism to lift the leg arms. The user can incrementally increase the leg split angle to the desired position and maintain that position for the desired duration. The user may further increase the angle or release as needed using the release handle to lower the legs in a controlled manner. The saddle stretch apparatus 100 provides a unique approach to leg and hip stretching by allowing the user to remain completely relaxed during use. By allowing the thighs to lift with the body in a standing position, similar to sitting on a horse, the apparatus 100 enables the legs to open against the gravity of the user's own weight while eliminating any strain induced by pulling the body towards the legs. This design promotes proper spine alignment and stimulates the concentration of core muscles and ligaments during the stretching process.

While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure.

While the present disclosure has been described with reference to one or more particular embodiments, those skilled in the art will recognize that many changes may be made thereto without departing from the spirit and scope of the description. Each of these embodiments and obvious variations thereof is contemplated as falling within the spirit and scope of the claimed invention, which is set forth in the following claims.

While the present disclosure has been described with reference to one or more particular embodiments, those skilled in the art will recognize that many changes may be made thereto without departing from the spirit and scope of the description. Each of these embodiments and obvious variations thereof is contemplated as falling within the spirit and scope of the claimed invention, which is set forth in the following claims.

What is claimed is:

1. A saddle stretch apparatus comprising:
a base frame;
an adjustable height mechanism coupled to the base frame;
a saddle seat coupled to the adjustable height mechanism;
a pair of leg lifting arms coupled to the base frame;
a gear mechanism operatively connected to the leg lifting arms; and
a control handle operatively connected to the gear mechanism for adjusting the position of the leg lifting arms.

2. The saddle stretch apparatus of claim 1, further comprising a backrest support coupled to the adjustable height mechanism.

3. The saddle stretch apparatus of claim 1, wherein the saddle seat comprises a split saddle pad seat.

4. The saddle stretch apparatus of claim 1, wherein the leg lifting arms are configured to move within a range of zero to 90 degrees.

5. The saddle stretch apparatus of claim 1, wherein the gear mechanism comprises a worm gear operatively connected to the leg lifting arms.

6. The saddle stretch apparatus of claim 1, further comprising a hydraulic or pneumatic pump system operatively connected to the leg lifting arms.

7. The saddle stretch apparatus of claim 6, further comprising a release button operatively connected to the hydraulic or pneumatic pump system for gradually lowering the leg lifting arms.

8. The saddle stretch apparatus of claim 1, wherein the leg lifting arms are configured to open in two perpendicular directions.

9. The saddle stretch apparatus of claim 1, further comprising cushion pads coupled to the leg lifting arms.

10. The saddle stretch apparatus of claim 1, wherein the base frame comprises lockable casters.

11. A method of using a saddle stretch apparatus, the method comprising:
mounting the saddle stretch apparatus by straddling a saddle seat;
adjusting the height of the saddle seat;
positioning legs on leg lifting arms;
operating a control handle to raise the leg lifting arms;
maintaining a desired stretch position; and
gradually lowering the leg lifting arms using a release mechanism.

12. The method of claim 11, further comprising engaging feet with a floor or base plate of the saddle stretch apparatus.

13. The method of claim 11, wherein operating the control handle comprises activating a ratchet mechanism to lift the leg lifting arms.

14. The method of claim 11, wherein maintaining the desired stretch position comprises incrementally increasing a leg split angle.

15. The method of claim 11, further comprising dismounting the saddle stretch apparatus from behind.

16. A saddle stretch system comprising:
a base frame with lockable casters;
an adjustable height cylinder assembly coupled to the base frame;
a split saddle pad seat coupled to the adjustable height cylinder assembly;
a pair of leg lifting geared arms coupled to the base frame;
a worm gear mechanism operatively connected to the leg lifting geared arms;
a crank lever operatively connected to the worm gear mechanism for adjusting the position of the leg lifting geared arms; and
cushion pads coupled to the leg lifting geared arms.

17. The saddle stretch system of claim 16, further comprising a backrest support coupled to the adjustable height cylinder assembly.

18. The saddle stretch system of claim 16, wherein the leg lifting geared arms are configured to move within a range of zero to 90 degrees.

19. The saddle stretch system of claim 16, further comprising a hydraulic or pneumatic pump system operatively connected to the leg lifting geared arms.

20. The saddle stretch system of claim 19, further comprising a release button operatively connected to the hydraulic or pneumatic pump system for gradually lowering the leg lifting geared arms.
